(19) United States
(12) Patent Application Publication
(10) Pub. No.: US 2023/0069400 A1
(43) Pub. Date: Mar. 2, 2023

(54) IMAGE FORMING APPARATUS THEREFOR

(71) Applicant: KYOCERA Document Solutions Inc., Osaka (JP)

(72) Inventor: Kota KAMISONO, Osaka (JP)

(73) Assignee: KYOCERA Document Solutions Inc., Osaka (JP)

(21) Appl. No.: 17/893,973

(22) Filed: Aug. 23, 2022

(30) Foreign Application Priority Data
Aug. 25, 2021 (JP) 2021-136874

(51) Int. Cl. G06F 3/04883; G06F 3/041; G06F 3/0482

(52) U.S. Cl. CPC G06F 3/04883; G06F 3/0416; G06F 3/0482

(57) ABSTRACT

When performing an edit process to add target information input by a handwriting operation to image data, a control portion makes a touch screen display a preview image, and an operation panel accepts a position specifying operation to specify a position in the preview image. When a position corresponding to a line space between a first line area and a second line area is specified, the control portion moves at least one of the first and second line areas to a position that does not overlap with the target information.

### INCORPORATION BY REFERENCE

This application is based on and claims the benefit of priority from Japanese Patent Application No. 2021-136874 filed on Aug. 25, 2021, the contents of which are hereby incorporated by reference.

### BACKGROUND

The present disclosure relates to an image forming apparatus.

A known image forming apparatus includes an image reading portion which reads a document. The conventional image forming apparatus, for example, displays on a touch screen a preview image corresponding to image data obtained by reading a document. The user can, by inputting letters by a handwriting operation on the touch screen on which the preview image is displayed, add the letters input by the handwriting operation to the image data of the document

### SUMMARY

According to one aspect of the present disclosure, an image forming apparatus includes an image reading portion, an operation panel, a control portion, and a print portion. The image reading portion reads a document. The operation panel includes a touch screen and accepts a handwriting operation on the touch screen. The control portion recognizes information input by the handwriting operation as target information to add to image data obtained by reading the document and generates edited image data by performing an edit process to add the target information to the image data. The print portion prints an image based on the edited image data on a sheet. The control portion, when performing the edit process, makes the touch screen display an edit screen with a preview image corresponding to the image data arranged on it and makes the operation panel accept an edit operation on the edit screen. The operation panel accepts a position specifying operation to specify a position on the preview image as the edit operation. The control portion divides a character area in the image data into line areas which are each a line-by-line area. The control portion, when a position corresponding to a line space between a first line area and a second line area is specified by the position specifying operation, moves at least one of the first and second line areas to a position that does not overlap with target information, and generates the edited image data in which the target information is arranged between the first and second line areas.

### BRIEF DESCRIPTION OF THE DRAWINGS

FIG. 1 is a block diagram showing an image forming apparatus of one embodiment.

FIG. 2 is a schematic diagram showing the image forming apparatus of the one embodiment.

FIG. 3 is a diagram showing an edit screen displayed on the operation panel on the image forming apparatus of the one embodiment.

FIG. 4 is a diagram showing a state where information has been input by a handwriting operation on the edit screen showing in FIG. 3.

FIG. 5 is a diagram illustrating a font change in target information performed on the image forming apparatus of one embodiment.

FIG. 6 is a diagram to illustrating a color change in target information performed on the image forming apparatus of one embodiment.

FIG. 7 is a diagram to illustrating a size change in target information performed on the image forming apparatus of one embodiment.

FIG. 8 is a diagram showing states of image data, before and after editing, edited on the image forming apparatus of one embodiment.

FIG. 9 is a diagram showing states of a preview image, before and after editing, displayed on the operation panel on the image forming apparatus of one embodiment.

FIG. 10 is a diagram illustrating a delete operation performed on the image forming apparatus of one embodiment.

### DETAILED DESCRIPTION

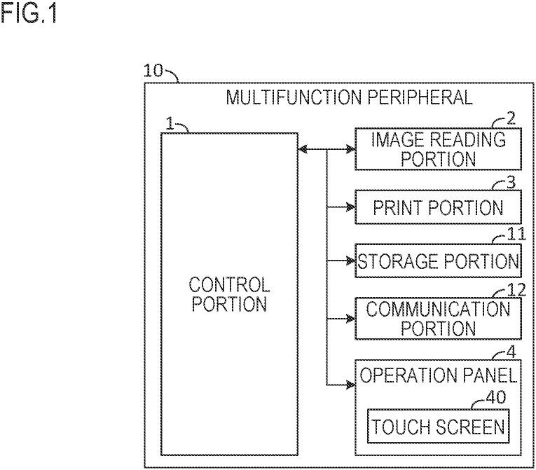

Hereinafter, an image forming apparatus will be described by taking a multifunction peripheral, which has multiple functions such as a copying function and the like, as an example.

<Construction of a Multifunction Peripheral> As shown in FIG. 1, a multifunction peripheral 10 has a control portion 1. The control portion 1 includes control circuits such as a CPU, an ASIC, and the like. The control portion 1 controls a job performed on the multifunction peripheral 10. One example of the job performed on the multifunction peripheral 10 is a print job based on print data transmitted from a personal computer (PC) as a user terminal. Another example is a print job based on scanned data (that is, a copy job).

The control portion 1 is connected to a storage portion 11. The storage portion 11 includes storage devices such as a ROM, a RAM, an HDD, and the like. The storage portion 11 stores a character recognition program. The control portion 1 performs an OCR (optical character recognition) process based on the character recognition program.

The control portion 1 is connected to a communication portion 12. The communication portion 12 includes a communication circuit and the like. The communication portion 12 is connected to, so as to be able to communicate with, an external device such as a user terminal and the like, across a network. The control portion 1 controls the communication portion 12 to communicate with the external device connected to the network.

The multifunction peripheral 10 includes an image reading portion 2. The image reading portion 2 reads a document D. The control portion 1 controls the image reading portion 2 to read the document D. The control portion 1 acquire image data obtained by scanning the document D by the image reading portion 2. In the copy job, printing is performed based on the image data of the document D. The OCR process (including a layout analysis) by the control portion 1 is performed on the image data of the document D.

The multifunction peripheral 10 includes a print portion 3. The print portion 3 conveys a sheet S. The print portion 3 prints an image on the sheet S while conveying it. The control portion 1 controls the print portion 3 to convey the sheet S and to print on it.

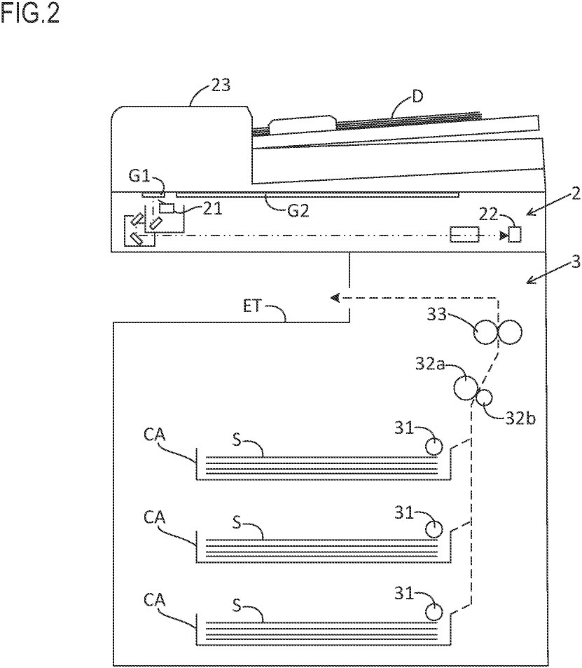

FIG. 2 is a schematic diagram of the image reading portion 2 and the print portion 3.

The image reading portion 2 includes a light source 21 and an image sensor 22. The light source 21 irradiates the document D with light. The image sensor 22 receives the light reflected by the document D and performs photoelectric conversion on it. In FIG. 2, the direction of the light traveling from the light source 21 to the image sensor 22 is indicated by a dash-dot-dot line. The light source 21 and the image sensor 22 are disposed inside a housing of the image reading portion 2.

Contact glasses G1 and G2 are attached to the top face of the housing of the image reading portion 2. The contact glass G1 is used in a conveyance reading mode. The contact glass G2 is used in a placement reading mode.

The image reading portion 2 includes a document conveyance unit 23. The document conveyance unit 23 is pivotably attached to the housing of the apparatus main body 2. The document conveyance unit 23 conveys the document D.

In the conveyance reading mode, the document D is set in the document conveyance unit 23. The document conveyance unit 23 conveys the document D toward the contact glass G1. The image reading portion 2 reads the document D passing across the contact glass G1.

In the placement reading mode, the document D is set on the contact glass G2. The image reading portion 2 reads the document D on the contact glass G2.

The print portion 3 conveys the sheet S along a sheet conveyance passage (indicated by a broken line in FIG. 2). The print portion 3 forms an image. The print portion 3 prints and outputs the image on the sheet S while conveying it.

The print portion 3 includes a sheet feed roller 31. The sheet feed roller 31 is in contact with the sheet S stored in a sheet cassette CA and, by rotating in that state, feeds the sheet S from the sheet cassette CA to the sheet conveyance passage.

The print portion 3 includes a photosensitive drum 32a and a transfer roller 32b. The photosensitive drum 32a carry a toner image on its circumferential surface. The transfer roller 32b is kept in pressed contact with the photosensitive drum 32a and forms a transfer nip between itself and the photosensitive drum 32a. The transfer roller 32b rotates together with the photosensitive drum 32a. The photosensitive drum 32a and the transfer roller 32b convey the sheet S having entered the transfer nip and meanwhile transfer the toner image to the sheet S.

Though not illustrated, the print portion 3 further includes a charging device, an exposure device, and a developing device. The charging device electrostatically charges the circumferential surface of the photosensitive drum. The exposure device forms an electrostatic latent image on the circumferential surface of the photosensitive drum. The developing device develops the electrostatic latent image on the circumferential surface of the photosensitive drum into a toner image.

The print portion 3 includes a pair of fixing rollers 33. The pair of fixing rollers 33 has a heating roller and a pressing roller. The heating roller includes a heater (not illustrated). The pressing roller is in pressed contact with the heating roller and forms a fixing nip between itself and the heating roller. The pair of fixing rollers 33 rotates and thereby, while conveying the sheet S having entered the fixing nip, fixes the toner image transferred on the sheet S to the sheet S. The sheet S having left the fixing nip is discharged to a discharge tray ET.

The printing method in the print portion 3 is not particularly limited. The printing method in the print portion 3 can be an electrophotographic method or an inkjet method.

Referring back to FIG. 1, the multifunction peripheral 10 includes an operation panel 4. The operation panel 4 is provided with a touch screen 40. The touch screen 40 includes a touch panel and a display panel (for example, a liquid crystal display panel). The touch screen 40 displays screens that show software buttons, messages, and the like. The touch screen 40 accepts operation on the displayed screen. The user performs a touch operation by bringing a contact body, such as his or her own finger or a touch pen, into contact with the touch screen 40. The operation panel 4 is provided with a variety of hardware buttons such as a start button for accepting a request to perform print job.

The operation panel 4 is connected to the control portion 1. The control portion 1 controls the display operation of the operation panel 4. The control portion 1 senses the operation performed on the operation panel 4. Specifically, the control portion 1 controls the touch screen 40. The control portion 1 makes the touch screen 40 display a screen showing software buttons and the like. The control portion 1 senses the operated software button based on the touch position on the touch screen 40. The control portion 1 recognizes that the software button which overlaps the touch position has been operated.

<Editing Image Data> In a copy job (that is, a print job involving reading of a document D), for example, the user uses the PC to create the document D as a copy source. The user then sets the document D on the multifunction peripheral 10 and makes the multifunction peripheral 10 perform the copy job. By operating the start button on the operation panel 4, the user can make the multifunction peripheral 10 perform the copy job.

Here, the user may want to change the contents of the document D after it is set in the multifunction peripheral 10. For example, the user can re-create the document D on the PC, but having to use a PC is troublesome for the user. The multifunction peripheral 10 thus has an edit function. Using the edit function, the user can change the contents of the copy source without the PC. For example, the operation panel 4 accepts a setting of whether to enable or disable the edit function.

The control portion 1, when the edit function is enabled, performs an edit process to edit the image data obtained by the image reading portion 2 reading the document D. The control portion 1 then performs an output process to output edited image data obtained by the edit process on the image data of the document D. For example, as the output process, the control portion 1 controls the print portion 3 to perform a print process based on the edited image data. That is, the print portion 3 prints an image based on the edited image data to the sheet S. As the output process, the control portion 1 may instead perform a process of converting the edited image data to predetermined data (such as PDF data) and saving this to an external device.

The edit process by the control portion 1 is performed based on an edit operation on the operation panel 4 by the user. That is, after the image reading portion 2 reads the document D, the operation panel 4 accepts the edit operation by the user.

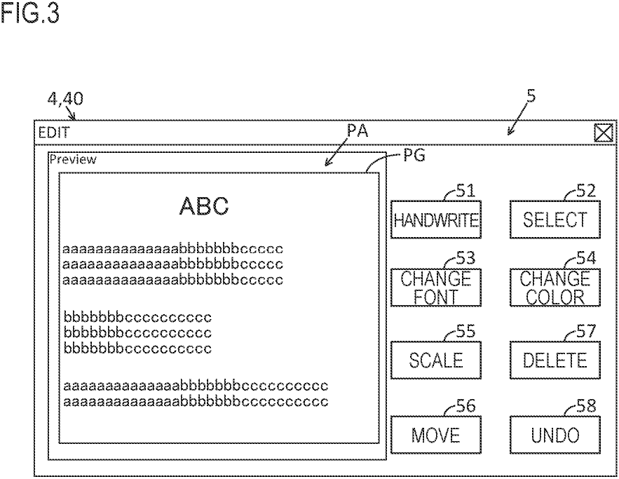

The control portion 1, when the edit process is performed, generates display data of a preview image PG (see FIG. 3) which corresponds to the image data obtained by the image reading portion 2 reading the document D. The preview image PG is an image for previewing the image data of the document D and is an image showing the contents of the document D. The control portion 1 then makes the touch screen 40 display an edit screen 5 as shown in FIG. 3 and makes the operation panel 4 accept the edit operation on the edit screen 5.

The operation panel 4 displays a screen on which the preview image PG is arranged as the edit screen 5 on the touch screen 40. The edit screen 5 includes a preview area PA. The preview image PG is arranged in the preview area PA. The edit screen 5 shown in FIG. 3 is one example and the layout and the like of the edit screen 5 can be changed.

FIG. 3 shows an edit screen 5 (preview image PG) seen when a document D with character strings on it has been read. In FIG. 3, for convenience' sake, the character strings on the document D are indicated with sequences of alphabetical letters.

The edit screen 5 is a screen including a plurality of edit buttons (software buttons). The plurality of edit buttons are arranged in an area outside the preview area PA. An operation of touching (tapping) one of the edit buttons on the edit screen 5 is accepted as one operation in the edit operation. Hereinafter, the plurality of edit buttons on the edit screen 5 will be described with reference numbers 51 to 58 respectively.

The control portion 1 performs the edit process to add user-specified information to the image data of the document D. The control portion 1 can add information to a blank part of the image data of the document D and can also add information to a character area (for example, between the lines).

The input of information to the image data of the document D is performed by a handwriting operation on the touch screen 40. That is, while the edit screen 5 is displayed, the control portion 1 makes the operation panel 4 accept the handwriting operation as one operation in the edit operation. The handwriting operation is an operation of moving the touch position on the touch screen 40 as if to handwrite information such as letters, numbers, symbols, and the like on the display surface of the touch screen 40.

The preview area PA is an area where the preview image PG is arranged and is also an area where the handwriting operation is accepted. For example, if the handwriting operation is performed outside the preview area PA, that operation is not accepted as the handwriting operation.

The operation panel 4 accepts a tapping operation on a handwrite button 51 as an edit button and then accepts the handwriting operation to input information to be added to the image data. The control portion 1 takes as valid the handwriting operation performed on the preview image PG after the handwrite button 51 is operated.

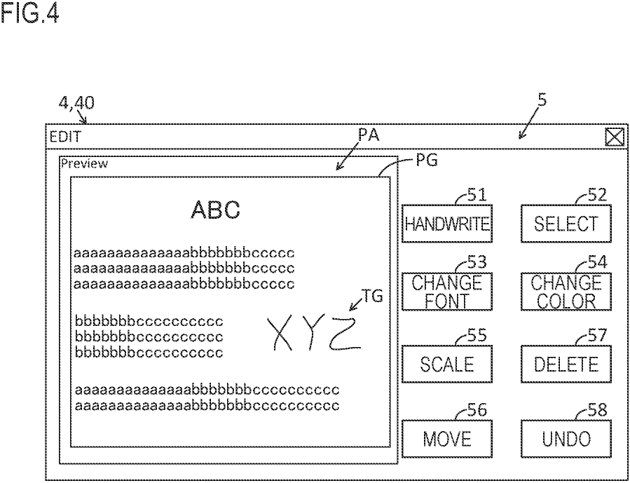

When the handwriting operation is performed on the edit screen 5, the control portion 1 detects the track of the handwriting operation on the edit screen 5. In other words, the control portion 1 detects the movement track of the touch position on the touch screen 40. The control portion 1 makes the operation panel 4 display a handwritten image which is an image along the track of the handwriting operation. The operation panel 4 displays a handwritten image on the track of the touch position by the handwriting operation on the touch screen 40. FIG. 4 shows the edit screen 5 with the handwritten image displayed on it. FIG. 4 shows the handwritten image resulting from the character string “XYZ” is input by the handwriting operation.

The control portion 1 recognizes information input by the handwriting operation by performing an OCR process to the handwritten image. The control portion 1 recognizes information including at least one of a character, a number, and a symbol (information which can be recognized in the OCR process) input by the handwriting operation as a target information TG to be added to the image data. In the example shown in FIG. 4, the control portion 1 recognizes the character string “XYX” as the target information TG. For example, if information input by the handwriting operation cannot be recognized by the OCR process, the control portion 1 makes the operation panel 4 display a message which prompts redoing the handwriting operation.

The control portion 1 makes the operation panel 4 accept a range select operation. The range select operation is one operation in the edit operation. The operation panel 4 accepts the operation performed after accepting the tapping operation on a range select button 52 as the range select operation.

Here, on the edit screen 5, the format of the target information TG can be changed. For example, the font, color, and size of the target information TG can be changed. The font, color, and size can be changed in the information (character image) within a range selected by the range select operation. Accordingly, if the font, color, and size of the target information TG is to be changed, the range select operation can be performed so that the target information TG is shown within the range.

The operation panel 4 accepts a font change operation to change the font of the target information TG as the edit operation. The edit buttons include a change font button 53. The operation panel 4 accepts a sequence of operations involving selecting the range including the target information TG by the range select operation and then tapping the change font button 53 as the font change operation. The font change operation includes an operation to specify one of a plurality of predetermined fonts.

For example, before an operation on the change font button 53, the operation panel 4 accepts a user-specified font. Or, after an operation on the change font button 53, the operation panel 4 accepts a user-specified font. The operation panel 4 displays on the touch screen 40 a plurality of fonts as candidates which can be specified and accepts one of the fonts specified by the user. When the operation panel 4 accepts the font change operation for the target information TG, the control portion 1 changes the font of the target information TG within the range selected by the range select operation to the user-specified font.

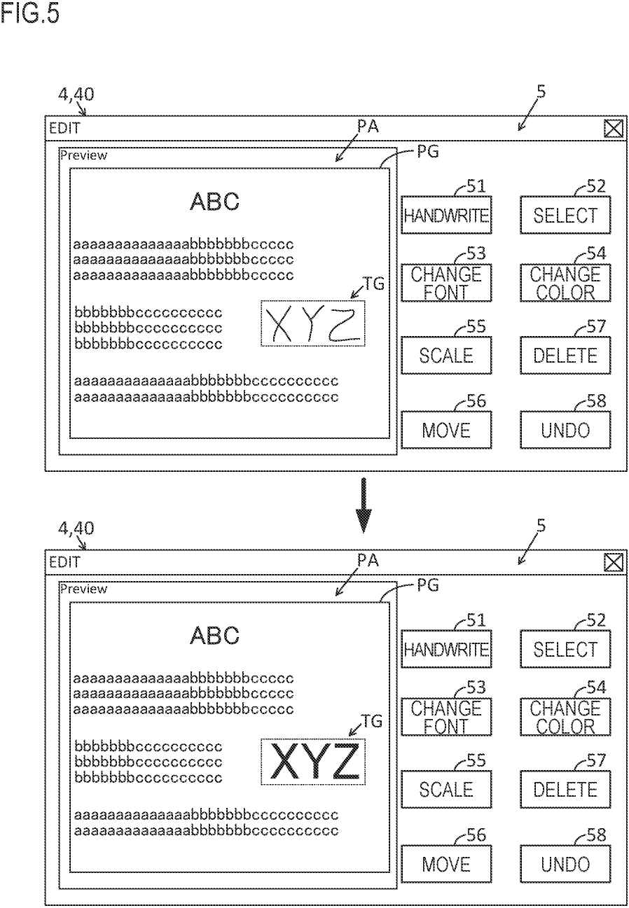

FIG. 5 shows states before and after the font change operation for the target information TG is performed. The upper part of FIG. 5 shows the state before the font change and the lower part of FIG. 5 shows the state after the font change. In FIG. 5, the range selected by the range select operation is indicated by a broken line. By performing the font change operation for the target information TG, it is possible to make the font of the handwritten letters input by the handwriting operation the same as the font used in the document D.

The range select operation can be omitted. In that case, the target information TG will automatically be targeted for the font change.

An existing character area in the image data of the document D may be taken as the target of the font change. In that case, the control portion 1 changes the font of the information within the range selected by the range select operation to the user-specified font regardless of whether it is the target information TG or not.

The operation panel 4 accepts a color change operation to change the color of the target information TG as one edit operation. The edit buttons include a change color button 54. The operation panel 4 accepts a sequence of operations involving selecting a range including the target information TG by the range select operation, tapping the change color button 54, and then specifying one of the colors from a color palette 540, which will be described later, as the color change operation.

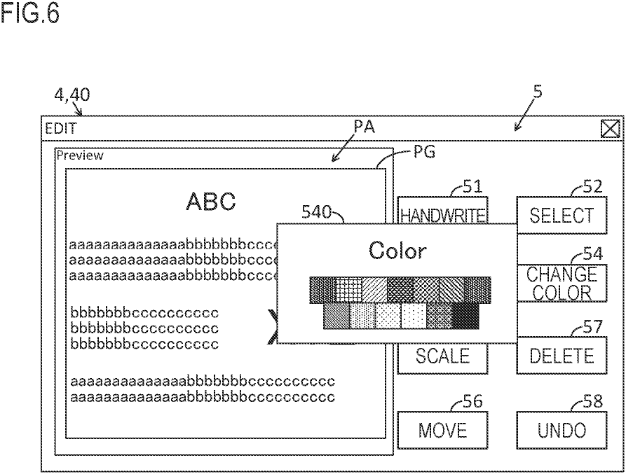

For example, when the change color button 54 is operated, the operation panel 4 displays a color palette 540 (see FIG. 6) on the touch screen 40. In FIG. 6, different colors on the color palette 540 are indicated by different patterns. The color palette 540 shown in FIG. 6 is one example and the color palette 540 is subject to no particular restrictions.

The operation panel 4 accepts one of the colors on the color palette 540 specified by the user. When the operation panel 4 accepts the color change operation for the target information TG, the control portion 1 changes the color of the target information TG within the range selected by the range select operation to the user-specified color. For example, the default color is black, and it is possible to change it to another color by performing the color change operation. The number of selectable colors is subject to no particular restrictions.

The range select operation can be omitted. In that case, the target information TG will automatically be targeted for the color change.

An existing character area in the image data of the document D may be taken as the target of the color change. In that case, the control portion 1 changes the color of the information (image) within the range selected by the range select operation to the user-specified color regardless of whether it is the target information TG or not.

The operation panel 4 accepts a size change operation to change the size of the target information TG as one edit operation. The size change operation is a scaling operation to zoom in or out on the target information TG. In other words, the size change operation is an operation of changing the font size of the target information TG presented with letters, numbers, symbols or the like. The edit buttons include a scale button 55. The operation panel 4 accepts a sequence of operations involving selecting a range including the target information TG by the range select operation, tapping the scale button 55, and then changing the distance between two points touched at the same time within the selection range, as the size change operation.

The operation panel 4 accepts a pinch-out operation performed within the range selected by the range select operation as an operation to increase the size of the target information TG. On the other hand, the operation panel 4 accepts a pinch-in operation performed within the range selected by the range select operation as an operation to reduce the size of the target information TG. The pinch-out operation is an operation of increasing the distance between two points touched at the same time on the touch screen 40. The pinch-in operation is an operation of reducing condensing the distance between two points touched at the same time on the touch screen 40.

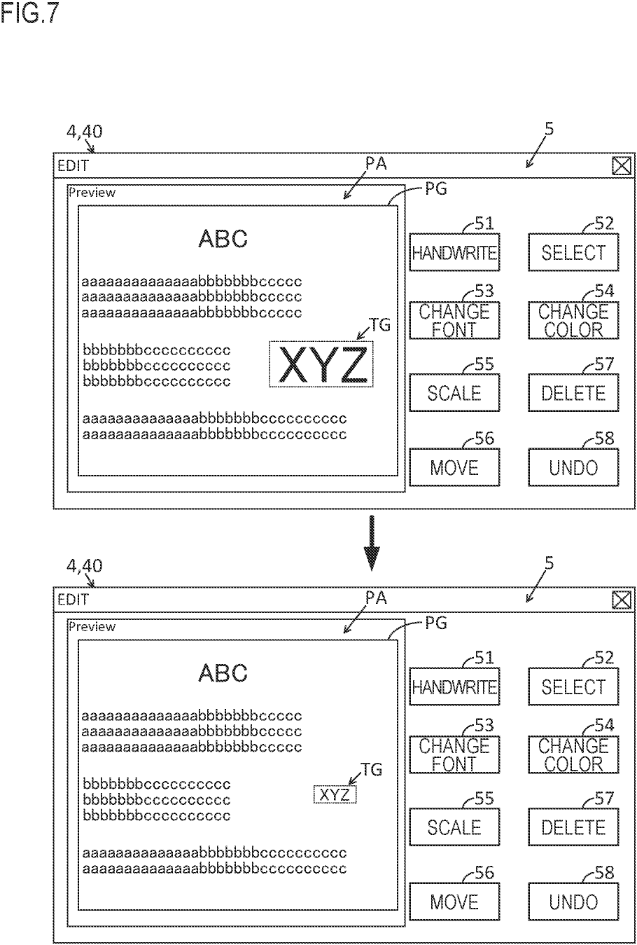

For example, as shown in FIG. 7, by performing the size change operation for the target information TG after making the font of the handwritten letters input by the handwriting operation the same as the font used in the document D, it is possible to make the font and the size of the handwritten letters input by the handwriting operation the same as the font and the size in the document D. The upper part of FIG. 7 shows the state before the size change is performed and the lower part of FIG. 7 shows the state after, as the size change operation, the pinch-in operation is performed to reduce the size of the target information TG.

The range select operation can be omitted. In that case, the target information TG will automatically be targeted for the size change.

An existing character area in the image data of the document D may be taken as the target of the size change. In that case, the control portion 1 changes the size of the information within the range selected by the range select operation to the user-specified size regardless of whether it is the target information TG or not.

On the edit screen 5, the position of the target information TG can be changed. In other words, the target information TG can be moved on the edit screen 5. For example, the movement of the target information TG is performed for the information within the range selected by the range select operation. Accordingly, if the target information TG is to be moved, the range select operation can be performed so that the target information TG is shown within the range.

Specifically, the operation panel 4 accepts a position specifying operation to specify a position on the preview image PG as one edit operation. The edit buttons include a move button 56. The operation panel 4 accepts a sequence of operations involving selecting a range including the target information TG by the range select operation, tapping the move button 56, touching the selection range, moving the touch position to the user-specified position, and then releasing the touch as the position specifying operation. In other words, the operation panel 4 accepts a drag-and-drop operation to set an area within the range selected by the range select operation (that is, the display area of the target information TG) as an operation start position, as the position specifying operation. The select operation can be omitted. In that case, the operation panel 4 accepts the drag-and-drop operation to set the operation start position on the display area of the target information TG as the position specifying operation.

When the operation panel 4 accepts a position specifying operation, the control portion 1 recognizes the position on the image data corresponding to the position specified by the position specifying operation on the preview image PG as a target position. In other words, the control portion 1 recognizes a position corresponding to the operation end position (the position where the touch is released) of the drag-and-drop operation, which is one operation in the position specifying operation, as the target position. The control portion 1 then generates edited image data in which the target information TG is arranged at the target position.

Here, the user may specify a position in the character area by the position specifying operation. In other words, a position in the character area may be the target position. For example, the user may want to arrange the target information TG between lines of text. In that case, a position in the character area is the target position.

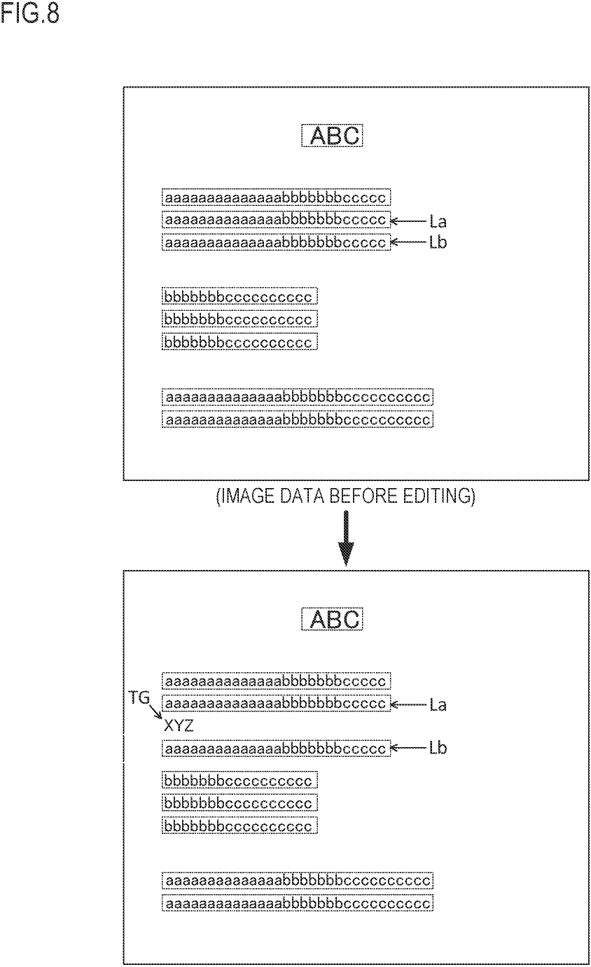

As shown in FIG. 8, the control portion 1 performs layout analysis for the image data obtained by reading the document D with the image reading portion 2. By performing the layout analysis, the control portion 1 recognizes the character area and the image area in the image data of the document D. The control portion 1 cuts out the character area in the image data line by line (decomposes the character area in the image data into single lines). In other words, the control portion 1 divides the character area in the image data into line areas which are each a line-by-line area in the image data. In other words, the control portion 1 recognizes the position of the line areas in the image data. In FIG. 8, the line areas are enclosed by broken lines.

When a line space in the character area, that is, the line space between a first line area and a second line area, which is the line area one line below the first, is specified by the position specifying operation, the control portion 1 moves at least one of the first and second line areas to a position that does not overlap with the target information TG, and moves the target information TG between the first and second line areas. Thus, the target information TG does not overlap with the existing line areas (the first and second line areas). The control portion 1 can move one of the first and second line areas in the direction away from the other, or can move both of them in the direction away from each other. For example, the second line area moves in the direction away from the first line area.

The control portion 1, when moving a line area, recognizes the font size of the target information TG and moves the line area by the recognized font size in a direction orthogonal to the line direction (the direction in which line areas extend, that is, the direction in which characters are written one after the next). In other words, the control portion 1 shifts the position of the line area by one line. If the document D is written horizontally, the line area is shifted in the vertical direction. If the document D is written vertically, the line area is shifted in the horizontal direction.

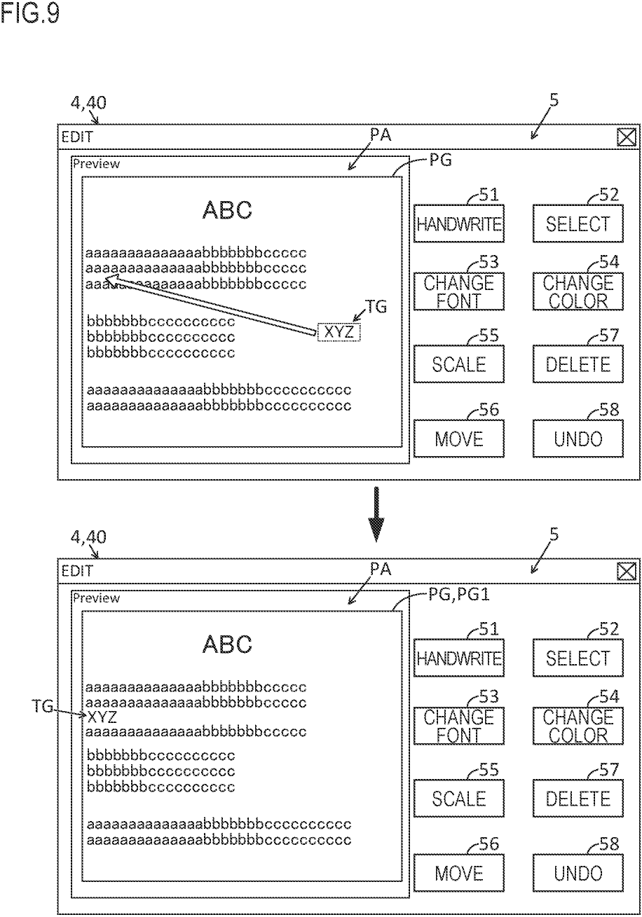

In the example shown in the upper part of FIG. 8, if the user wants to arrange the target information TG one line below the line area La (if the user wants to arrange the target information TG at the position of the line area Lb), the user, as shown in the upper part of FIG. 9, specifies a position corresponding to the line space between the line areas La and Lb in the preview image PG by the position specifying operation. In other words, the user touches the display area of the target information TG and moves the touch position to a position corresponding to the line space between the line areas La and Lb in the preview image PG. In other words, the user performs a drag-and-drop operation so as to move the target information TG to a position corresponding to the line space between the line areas La and Lb in the preview image PG. In the upper part of FIG. 9, the movement track of the touch position is indicated by a hollow arrow.

The control portion 1, when the position specifying operation is performed as shown in the upper part of FIG. 9, generates edited image data as shown in the lower part of FIG. 8 by performing the edit process on the image data as shown in the upper part of FIG. 8. Specifically, the control portion 1 shifts the line area Lb one line below, arranges the target information TG between the line areas La and Lb, and generates the edited image data.

As shown in the lower part of FIG. 9, the control portion 1, when it has generated the edited image data, generates the preview image PG corresponding to the edited image data. In the following description, the preview image PG corresponding to the edited image data is identified by the reference sign PG1 and referred to as an edited preview image PCi1 for distinction from the preview image PG corresponding to the image data before editing.

The control portion 1 displays the edited preview image PG1 on the operation panel 4 (touch screen 40). The operation panel 4 displays the edit screen 5 with the edited preview image PG1 arranged on it. That is, the operation panel 4 switches what is displayed in the preview area PA from the preview image PG before editing to the edited preview image PG1.

While the edit screen 5 with the edited preview image PG1 arranged on it is being displayed, the control portion 1 makes the operation panel 4 accept the edit operation. That is, the control portion 1 makes the operation panel 4 accept the edit operation to edit the edited image data. The user can edit the image data repeatedly, even after editing the image data once.

The operation panel 4 accepts a delete operation as one edit operation. The edit buttons include a delete button 57. The operation panel 4 accepts a sequence of operations involving selecting a range by the range select operation and then tapping the delete button 57 as the delete operation.

The delete operation is an operation of deleting any area (including the area of target information TG) in the image data of the document D. In the range select operation as one operation in the delete operation, a range is selected in the preview image PG (including the edited preview image PG1). Then, it is possible to delete the area within the range selected by the range select operation in the image data of the document D.

Specifically, the control portion 1 recognizes the area within the range selected by the range select operation in the image data of the document D as a target to be deleted. The control portion 1 then generates edited image data with the color of the area to be deleted changed to the background color. The control portion 1 also makes the operation panel 4 display the edit screen 5 with the edited preview image PG1 corresponding to the edited image data arranged on it.

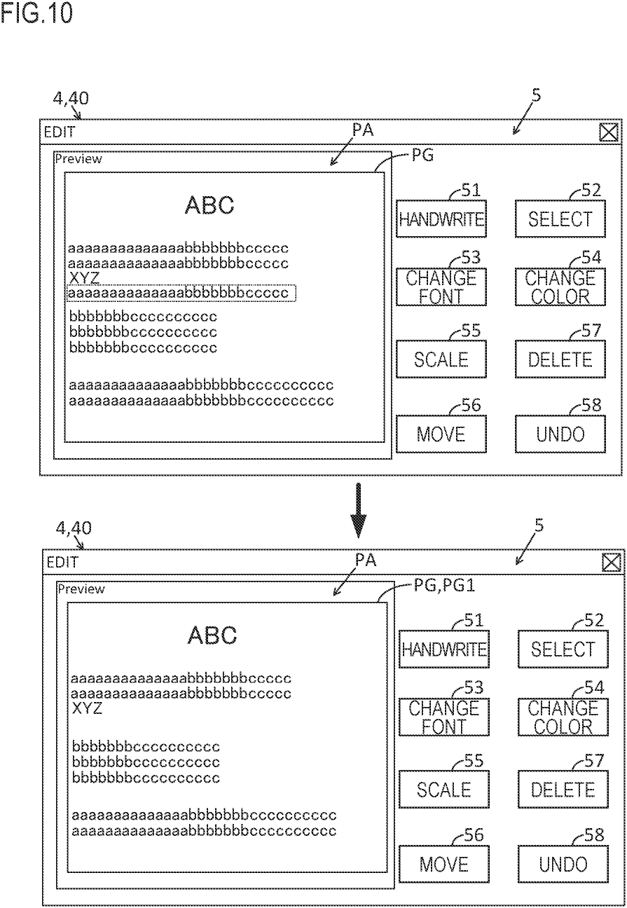

For example, as shown in FIG. 10, if the user wants to delete the line one line below the character string “XYX”, the user can select a range including the line to be deleted by the range select operation and then tap the delete button 57. Thus the edit process of deleting that line from the image data is performed and the edited preview image PG1 corresponding to the edited image data is displayed anew in the preview area PA on the edit screen 5. In FIG. 10, the upper part shows the edit screen 5 before the edit operation and the lower part shows the edit screen 5 after the edit operation. The range selected by the range select operation is enclosed by broken lines.

The operation panel 4 accepts an operation to edit back the edited image data to the image data before editing. In other words, the operation panel 4 accepts a cancel operation to cancel the editing done in the image data of the document D. The edit buttons include a cancel button 58. The cancel button 58 is, for example, a software button indicated “undo”. The operation panel 4 accepts an operation tapping the cancel button 58 as the cancel operation.

The control portion 1 makes the storage portion 11 store the initial image data obtained by the reading the document D (that is, the image data before editing). When the operation panel 4 accepts the cancel operation, the control portion 1 makes the touch screen 40 display the preview image PG corresponding to the image data before editing arranged on the edit screen 5. That is, what is displayed in the preview area PA switches from the edited preview image PG1 to the preview image PG before editing.

The operation panel 4, while the edit screen 5 is displayed, accepts from the user a request to end the edit operation on the image data. Though not illustrated, an end button (software button) for accepting a request to end the edit operation on the image data can be arranged on the edit screen 5. Or one of the hardware buttons on the operation panel 4 may be chosen to function as the end button.

When the operation panel 4 accepts a request to end the edit operation on the image data, the control portion 1 performs the output process on the image data corresponding to the preview image PG displayed currently in the preview area PA on the edit screen 5. That is, the control portion 1 makes the print portion 3 perform printing based on the image data corresponding to the preview image PG displayed currently in the preview area PA on the edit screen 5. If the preview image PG before editing is displayed on the edit screen 5, the printing is performed based on the image data before editing. If the edited preview image PG1 is displayed on the edit screen 5, the printing is performed based on the edited image data.

In this embodiment, as described above, the control portion 1 divides the character area in the image data obtained by reading the document D with the image reading portion 2 into a plurality of line areas. That is, the control portion 1 divides the character area in the image data of the document D into lines. Thus, when the position corresponding to the line space between the first and second line areas La and Lb is specified by the position specifying operation (See FIGS. 8 and 9), the line space between the first and second line areas La and Lb can be expanded, and the target information TG can be arranged (inserted) in the line space between the first and second line areas La and Lb. Even when the target information TG is arranged in the line space between the first and second line areas La and Lb, since that line space is expanded, the first and second line areas La and Lb does not overlap with the target information TG.

With this configuration, it is easy to expand a line space between lines of text in the image data obtained by reading the document D and add information there. From the user’s point of view, this is convenient because the user then does not need to re-create the document D on the PC.

In this embodiment, as described above, the operation panel 4 accepts the font change operation as an edit operation. It is thus possible to change information input by the handwriting operation (handwritten letters) to the user-specified font.

In this embodiment, as described above, the operation panel 4 accepts the color change operation as an edit operation. It is thus possible to change information input by the handwriting operation to the user-specified color.

In this embodiment, as described above, the operation panel 4 accepts the size change operation as an edit operation. It is thus possible to change information input by the handwriting operation to the user-specified size.

In this embodiment, as described above, the operation panel 4 accepts the delete operation as an edit operation. It is thus possible to delete (change to the same color as the background color) the user-specified area in the image data of the document D.

Through acceptance of such edit operations, it is easy to obtain image data edited as the user desires (edited image data), even without the user re-creating the document D on the PC or the like. This improves user convenience.

It should be understood that the embodiment disclosed herein is in every aspect illustrative and not restrictive. The scope of the present disclosure is defined not by the description of the embodiment given above but by the appended claims, and encompasses any modifications made without departure from the scope and sense equivalent to those claims.

What is claimed is:

1. An image forming apparatus comprising:
an image reading portion which reads a document;
an operation panel which includes a touch screen and which accepts a handwriting operation on the touch screen;
a control portion which recognizes information input by the handwriting operation as target information to add to image data obtained by reading the document and which generates edited image data by performing an edit process to add the target information to the image data; and
a print portion which prints an image based on the edited image data on a sheet,
wherein
the control portion, when performing the edit process, makes the touch screen display an edit screen with a preview image corresponding to the image data arranged thereon and makes the operation panel accept an edit operation on the edit screen,
the operation panel accepts a position specifying operation to specify a position on the preview image as the edit operation,
the control portion divides a character area in the image data into line areas which are each a line-by-line area, and
the control portion, when a position corresponding to a line space between a first line area and a second line area is specified by the position specifying operation, moves at least one of the first and second line areas to a position that does not overlap with the target information, and generates the edited image data in which the target information is arranged between the first and second line areas.

2. The image forming apparatus according to claim 1, wherein
when the operation panel accepts a font change operation as the edit operation, the control portion changes a font of the target information to a user-specified font.

3. The image forming apparatus according to claim 1, wherein
when the operation panel accepts a color change operation as the edit operation, the control portion changes a color of the target information to a user-specified color.

4. The image forming apparatus according to claim 1, wherein
when the operation panel accepts a size change operation as the edit operation, the control portion changes a size of the target information to a user-specified size.

5. The image forming apparatus according to claim 1, wherein
when the operation panel accepts a delete operation as the edit operation, the control portion changes a color of the area within a user-specified range in the image data to a background color.

6. The image forming apparatus according to claim 1, wherein
having generated the edited image data, the control portion makes the touch screen display the edit screen with an edited preview image corresponding to the edited image data arranged thereon and makes the operation panel accept the edit operation.
